(19) United States
(12) Patent Application Publication
(10) Pub. No.: US 2010/0293596 A1
(43) Pub. Date: Nov. 18, 2010

(54) METHOD OF AUTOMATICALLY DEFINING AND MONITORING INTERNAL NETWORK CONNECTIONS

(75) Inventor: Robert F. Terry, Old Hickory, TN (US)

Correspondence Address: MILES & STOCKBRIDGE PC, 1751 PINNACLE DRIVE, SUITE 500, MCLEAN, VA, 22102-3833, US

(73) Assignee: CWI, Ellwood City, PA (US)

(21) Appl. No.: 12/440,329

(22) PCT Filed: Sep. 7, 2007
(86) PCT No.: PCT/US07/77946

§ 371 Date: Apr. 26, 2010

Related U.S. Application Data
(60) Provisional application No. 60/824,818, filed on Sep. 7, 2006.

(51) Int. Cl. G06F 21/20

(52) U.S. Cl. 726/3

(57) ABSTRACT

A method of defining network connection policies, deploying the network connection policies and monitoring all network connections, including an automated real-time analysis and intercepting all connections, and determining whether those network connections are private access connections, or public access connections. If the public access connections are unauthorized, terminating the public access connections in communications port for authorized connections.

### CROSS REFERENCE TO RELATED APPLICATION

This application claims benefit of priority to U.S. Provisional Patent Application No. 60/824,818, filed Sep. 7, 2006, which is herein incorporated in its entirety by reference.

### FIELD OF THE INVENTION

This method of invention relates generally to the field of network utility professional programming, and more particularly but not exclusively, to defining internal network communications policies, deploying those policies throughout the internal network and methods of intercepting internal network communications and determining if the connections are authorized or unauthorized in a real-time environment.

### BACKGROUND OF INVENTION

As networking and automation expands in business and organizations, one of the most important new services in today's modern network computing is the ability for organizations to establish free network access to the Internet from their own internal operational network. In essence, organizations are establishing “connection points” and are allowing “connectivity” from their internal Local Area Network, (LAN), to the Internet and any other public network. Many public corporations, private corporations, state and federal government organizations, including the Department Of Defense, now allow direct public access (“connectivity”) to their LAN for employees and visitors to those organizations. For example, many major commercial corporations and U.S. Government Agencies provide available network connections as a service for their employees and visitors who meet with those organizations.

Compounding the issue is that frequently an individual, who is allowed access and utilizes an organization's network, not only has 100% administrative access rights (i.e., privileges) to his/her computer, but also has administrative access rights to the organization's network while the individual is connected to and utilizing the organization's network.

Another issue, is that a 32/64-bit Microsoft computer automatically creates hidden “administrative shares” for its logical drives C:, D:, etc., which it names C$, D$, etc., respectively. The 32/64-bit Microsoft computer also creates an Admin$ hidden share for the \WINNT or \Windows folder. Domain administrators design these shares for remote access support. By default, if these administrative shares are deleted, they are automatically recreated when the computer is rebooted. These active “administrative shares” allow any individual user, to remotely log into a 32/64-bit Microsoft computer, if the remote user knows the system name and password of that particular computer. What compounds the issue is that an individual, who is allowed to access and utilize an organization's host LAN, frequently has 100% administrative access rights (i.e., privileges) to their computer, while they are connecting into and utilizing the host LAN. Other shares may also be of issue, including, but not limited to, an ipc$ share, which is a network share that is used to facilitate communication between processes and computers. This share is often used to exchange authentication data between computers.

The problem becomes much more complicated when an organization attempts to apply the most current, common technology solutions available in the industry, to combat the problems as defined in the previous paragraphs.

The current technical solutions for these defined problems are firewalls and intrusion detection systems (IDS). The biggest problem with all the current technical solutions (firewalls and IDS) is that great measures must be taken to separate and secure the normal operational network (i.e., private access network) used by an organization, from network connections made available for public access to visitors (i.e., public access network).

As an example, the separation of an internal LAN's private access network from public access network “connection points”, requires additional hardware, including the implementation of additional computers and software, which are 100% dedicated to monitoring and securing the “internal LAN connectivity” or “security gateway” between the private access network and the public access network. These additional dedicated computers and software perform one “single security service”, that is, monitoring all connectivity between the private access network and public access network and determining whether those connections are authorized or unauthorized. If the public access network connections are unauthorized, the dedicated computer and software terminate the network connection before any damage can be sustained by the private access network.

Based on the design architecture of the previous described security solution, the entire security protection for a private access network from a public access network is a single “security gateway”, that if successfully breached by an attacker, makes every computer within the private access network open and vulnerable to any kind of computer attack.

As an example, a current state-of-the-art Microsoft 32-bit computer, or a 64-bit Microsoft computer may be used by an individual to connect to a public access connection service made available by an organization. However, this organization may also use the same network as their private network to conduct their normal business operations. Obviously, the private network must be protected from visitors who utilize any of the public connections made available by the network. Protection is especially required from an individual visitor who has administrative privileges and tools installed in his/her computer that enables the individual to automatically “probe” the network to find security holes and/or weaknesses through the “security gateway” between the public access network “connection points” and the private access network. If the tools are successful in retrieving certain information, the user can defeat the “security gateway” and gain access into the private access network and retrieve information from any computer and/or device from within the private access network.

Because of the problems described in the previous paragraphs, a new technology (such as, for example, a utility) is needed that does not depend on a security architecture and that does not act as a single “security gateway” between the private access network and the public access network.

Instead of a single “security gateway”, the new technology may take advantage and utilize every computer within the private access network as a defense mechanism against any computer that attempts an unauthorized connection from the public access network into the private access network. For example, such a solution should have the ability to perform an analysis of a computer or a server, for example, a 32/64-bit Microsoft PC or Server, from the time the computer or server is turned-on (i.e., boots-up), including executing an analysis of the computer's or server's internal communications configuration. The computer or server can then be configured for “secure communications” by applying internal communication policies. These internal communication policies automatically define and separate all the possible authorized connections within the private access network from the possible connections from any computer utilizing any connection defined as a public access connection and only allowing direct connections inside the LAN from authorized computers from the private access network.

Additionally, the solution should allow the use of all logical communication ports and, if an unauthorized event occurs, then terminate the event and allow authorized communications to continue on the same logical port.

The solution should also utilize every computer within the private access network to provide a security defense-in-depth architecture scenario and force a potential hacker to not simply breach a single “security gateway”, but would require the potential intruder to successfully defeat a security architecture that utilizes every computer as an internal defense mechanism within the private access network.

### SUMMARY

Embodiments of the present invention can provide a method of executing and performing an analysis of a 32/64-bit Microsoft computer's internal communications configuration, to automatically apply connection policies and configure the computer for “secure communications”, by only allowing direct connections inside the private access network from authorized computers with approved connection policies. Embodiments can also automatically terminate any attempted connection from a computer that is utilizing a defined connection from the public access network. Additionally, embodiments may configure the network computer to allow the use of all logical communication ports and, if an unauthorized event occurs, can terminate that event, but allow authorized communications to continue on the same logical port.

### BRIEF DESCRIPTION OF DRAWINGS

Non-limiting and non-exhaustive embodiments of the present invention are described with reference to the following figures, wherein like reference numerals refer to like parts throughout the various views unless otherwise precisely specified.

FIG. 1 is a general flow diagram of a method that can be performed after the communications configuration and connection policies are applied to the computer and how the computer performs a real-time analysis on all connections and determines if those connections or authorized or unauthorized, in accordance with at least one embodiment of the present invention.

FIG. 2 is a detailed flow diagram of a method of retrieving all IP addresses and MAC codes to operate in a secure manner inside the host LAN and illustrating the mechanics required to establish an interlink into the operating system Winsock and Iphlapi (i.e., operating system APIs) to capture the Transmission Control Protocol (TCP) and User Datagram Protocol (UDP) Table entries, in accordance with at least one embodiment of the present invention.

FIG. 3 is a detailed flow diagram of a method for establishing an interlink into the NetAPI (i.e., operating system API) to check for the existence of specific network shares (i.e., communications shares) and retrieving all remaining active network shares, in accordance with at least one embodiment of the present invention.

FIG. 4 is a detailed flow diagram of a method that can be performed after the initial installation and analysis of the computer to start parallel threads to monitor all TCP/UDP tables (activity) and active network shares (i.e., communications shares), in accordance with at least one embodiment of the present invention.

FIG. 5 is a detailed flow diagram of a method that can be performed after the initial installation and analysis of the computer to start parallel threads to monitor all active network shares (i.e., communications shares), in accordance with at least one embodiment of the present invention.

FIG. 6 is a detailed flow diagram of a method of monitoring the active TCP and UDP tables (connections) and determining if those connections are within policy (allowed) or not within policy (disallowed) and to be automatically disconnected, in accordance with at least one embodiment of the present invention.

FIG. 7 is a block diagram of a computer system that may be used in accordance with at least one embodiment of the present invention.

FIG. 8 is a diagram of a multiple network system that may be used in accordance with at least one embodiment of the present invention.

### DETAILED DESCRIPTION OF ILLUSTRATED EMBODIMENTS

In the description herein, general details are provided in flow diagrams, to provide a general understanding of the programming methods that will assist in an understanding of embodiments of the inventive methods. One skilled in the relevant art of programming will recognize, however, that the inventive method can be practiced without one or more specific details, or in other programming methods. Terms referenced throughout this specification to “one embodiment” or “an embodiment” means that a particular feature, structure or characteristic described in connection with the embodiment is included in at least one embodiment of the present inventive method. Thus, the appearance of the phrases “in one embodiment” or “in an embodiment” in places throughout this specification are not necessarily all referring to the same embodiment. Furthermore, the particular features, structures, or characteristics may be combined in any suitable manner in one or more embodiments.

As an overview, the ability for a programmer to design and develop an operating system (O/S) utility may be based on the capabilities of the O/S NetAPI functions, Winsock and those functions that allow an interface to gather information critical to files that reside within the O/S Winsock. In accordance with one or more embodiments of the present invention, the O/S utility may be developed or implemented in a variety of programming languages ranging from low-level, programming languages (e.g., but not limited to, assembler) to high-level programming languages (e.g., but not limited to, C++, Visual Basic, Java, Java Beans, etc.). The O/S utility may be stored or encoded as an executable file on a machine-readable and/or a computer-readable medium (e.g., but not limited to, a floppy disk, a hard drive, a flash drive, a bubble memory, a Read Only Memory (ROM), a Random Access Memory (RAM), or the like) and/or hardwired into one or more integrated circuits (e.g., an Electrically Erasable Programmable Read Only Memory (EEPROM), an Erasable Programmable Read Only Memory (EPROM), etc.).

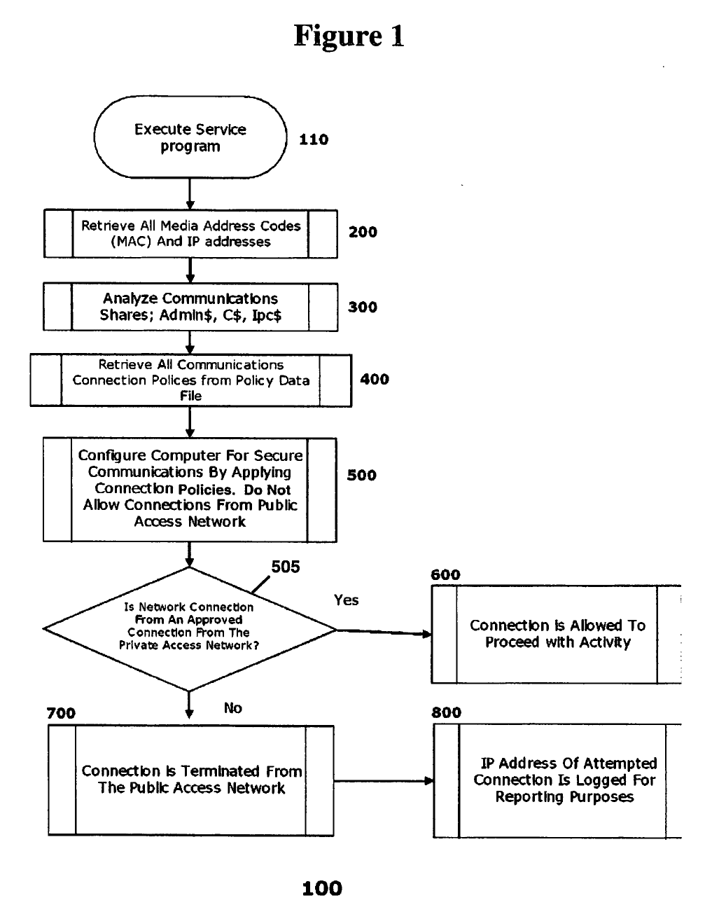

FIG. 1 is a general flow diagram of a method 100 that can be performed after the communications configuration and connection policies are applied to the computer and how the computer may perform a real-time analysis on all connections and determine whether those connections or authorized or unauthorized, in accordance with at least one embodiment of the present invention. In FIG. 1, there is shown a detailed flow diagram of an O/S utility program executing (110) as a service from the time the computer is powered-on (i.e., booted-up) and retrieving (200) Media Access Codes (MAC) and IP addresses from the computer and performing a basic analysis of the communications configuration of the computer, analyzing (300) and securing the network shares (i.e., communications shares), and reading (i.e., retrieving) (400) all communications connections policies, for example, TCP connections policies.

In FIG. 1, after the TCP connection policies are retrieved, the TCP connection policies may be applied to configure (500) the computer for secure communications by applying the retrieved connections policies to enable determining (505) whether all attempted connections in a real-time environment are allowable. If the attempted connection is determined (505) to be within the approved policy (i.e., allowable), the connection may be allowed to proceed (600). However, if the connection is determined (500) not to be within the approved policy parameters, the connection may be terminated (700) and the IP address of the attempted connection is logged (800) for reporting purposes.

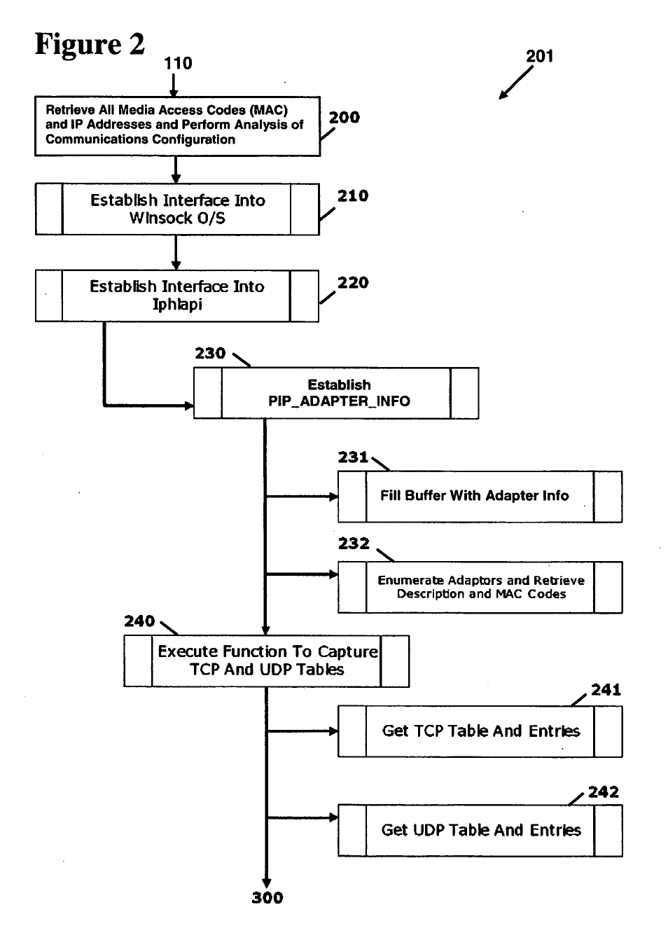

FIG. 2 is a detailed flow diagram of a method 201 of retrieving all IP addresses and MAC codes to operate in a secure manner inside the host LAN and illustrating the mechanics required to establish an interlink into the operating system Winsock and Iphlapi (i.e., operating system APIs) to capture the Transmission Control Protocol (TCP) and User Datagram Protocol (UDP) Table entries, in accordance with at least one embodiment of the present invention. In FIG. 2, there is shown a detailed flow diagram of the service program retrieving (200) all MAC codes and IP addresses and performing an analysis function of the communications configuration of the computer by initially establishing (210) an interlink/interface into the operating system Winsock and establishing (220) an interlink/interface into the operating system Iphlapi (O/S API). Once the interfaces/interlinks into the Winsock and Iphlapi are established (210, 220, respectively), the next function may then establish (230) a PIP_ADAPTER_INFO Table and fill (231) a buffer with adapter information. The function may then traverse (i.e., enumerate) (232) the adaptor table to record all MAC codes utilized by the computer. A function may then execute (240) to capture the TCP and UDP tables using a get (241). After the TCP table and its entries are obtained (241) and the UDP table and its entries are obtained (242), the TCP and UDP tables are stored in a memory in the computer, and the service program may continue on to analyze (300) the network shares (i.e., communications shares).

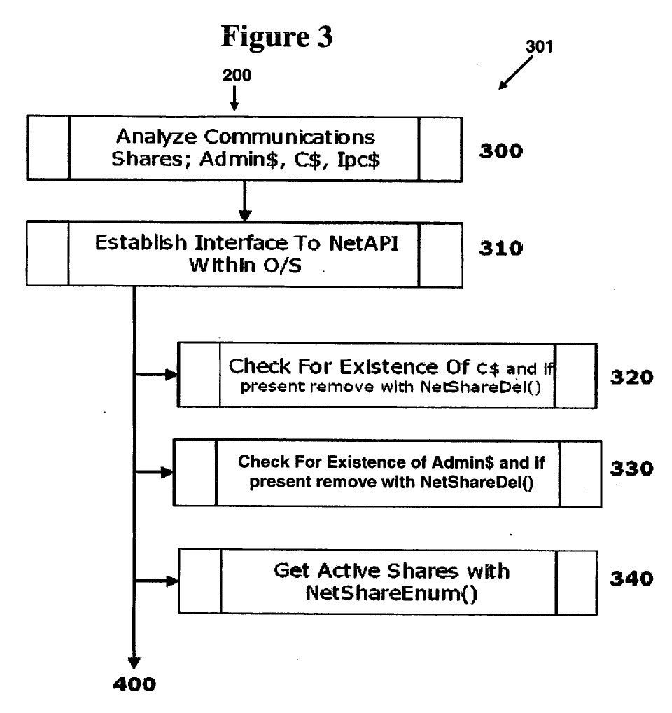

FIG. 3 is a detailed flow diagram of a method 301 for establishing an interlink into the NetAPI (i.e., operating system API) to check for the existence of specific network shares (i.e., communications shares) and retrieving all remaining active network shares, in accordance with at least one embodiment of the present invention. In FIG. 3, there is a shown a detailed flow diagram of the service program initiating a function to analyze (300) and capture network communications shares (i.e., network shares). Capturing the active network communications shares can include establishing (310) an interlink/interface into the operating system NetApi (O/S API), then executing (320) a function specifically to check for the existence of network share C$ and executing (330) a function specifically to check for the existence of network share Admin$ and, if these shares are present, to delete (i.e., remove) these shares with a NetShareDel( )function to prevent a possible security threat from C$ and Admin$ shares. Finally, the service program captures (340) all remaining active shares by executing a NetShareEnum( )function and recording this information into a data file and then continuing to the reading (400) of the TCP connection policies function.

Referring back to FIG. 1, there is shown the retrieving (400) all communications connection policies (i.e., TCP connection policies), which specifically are retrieved by executing a fopen( )function, a fread( )function, and de-crypted by establishing an interlink/interface into an operating system crypto API. When the policy data file is de-crypted it is applied to the functions that initiate extended parallel threads to monitor all formal TCP connections to determine (505) whether each network connection is from an approved connection from the private access network. For example, the connection policies can range from defining a specific policy to:
1) Allowing a specific defined connection—example 100.200.100.101
2) Disconnecting a specific defined connection—example 100.200.100.102
3) Allowing a specific range of IP addresses to connect. For example 100.100.100.101 to 100.100.100.150
4) Disconnecting a specific range of IP addresses. For example 100.200.150.200 to 100.200.150.250.

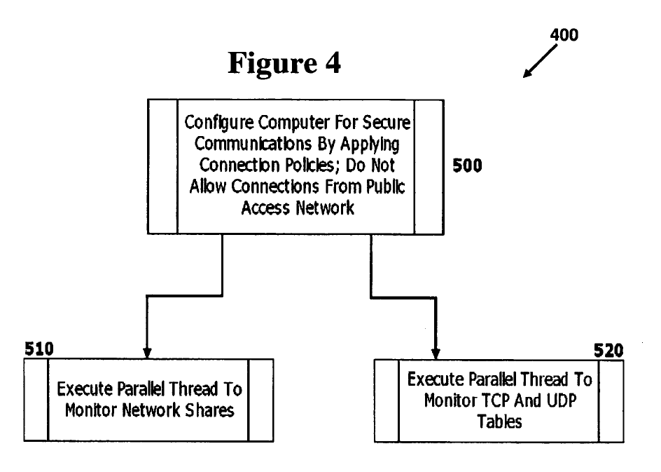

FIG. 4 is a detailed flow diagram of a method 401 that can be performed after the initial installation and analysis of the computer to start parallel threads to monitor all TCP/UDP tables (activity) and active network shares (i.e., communications shares), in accordance with at least one embodiment of the present invention. In FIG. 4, there is shown a detailed flow diagram of the service program method after configuring (500) and securing the communications configuration (i.e., environment), including starting two external parallel threads to continuously cycle and monitor the communications activity. Specifically, a first parallel thread may be executed (510) to monitor network shares and a second parallel thread may be executed (520) to monitor all TCP and UDP communications.

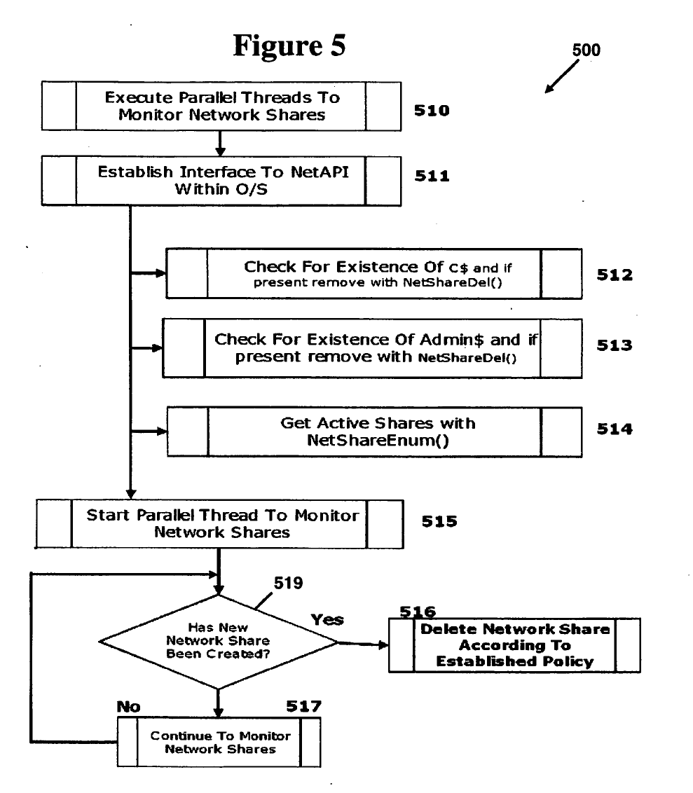

FIG. 5 is a detailed flow diagram of a method 501 that can be performed after the initial installation and analysis of the computer to start parallel threads to monitor all active network shares (i.e., communications shares), in accordance with at least one embodiment of the present invention. In FIG. 5, details of the service program method starting (i.e., executing) (510) the external parallel thread to monitor and secure all network share(s) activity are shown. In particular, the parallel thread may establish (511) an interlink/interface into the NetAPI operating system API, then check (512, 513, respectively) for the existence of C$ and Admin$ and, if present, delete these shares with a NetShareDel( )function, then retrieve (514) the remaining active shares by executing a NetSharesEnum( )function. Once these steps are completed, the parallel thread may then execute (515) its polling cycle to continuously monitor network share activity. During the continuous monitoring, if a network share is determined (519) to have been dynamically created, the network share may be automatically deleted (516). Conversely, if it is determined (519) that no network share has been created, the parallel thread may loops back to continue to monitor (517) the configuration state of the computer's network shares.

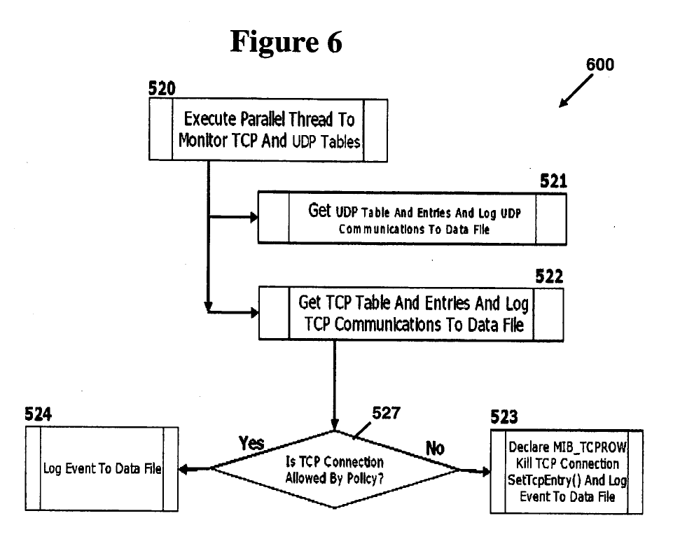

FIG. 6 is a detailed flow diagram of a method 601 of monitoring the active TCP and UDP tables (connections) and determining if those connections are within policy (allowed) or not within policy (disallowed) and to be automatically disconnected, in accordance with at least one embodiment of the present invention. In FIG. 6, there is shown a detailed flow diagram of the service program method starting (i.e., executing) (520) an external parallel thread to monitor and secure all TCP and UDP communications are shown. The external parallel thread may retrieve (521) the UDP table and log teh UDP communications to a data file, then retrieve (522) the TCP table and log the TCP communications to a data file, which may or may not be the same as the data file in which the UDP communications are logged. The external parallel thread may then cycle all active TCP and UDP connections and compare the connections to the IP policies defined as authorized connections to determine whether the connections are allowed. If a TCP connection is determined to have an approved IP Policy, (i.e., within the established IP specific (or range) policy), the connection may be allowed to proceed and the event logged (524) into a data file, which may or may not be the same as the data file in which the UDP and/or TCP communications are logged. If the TCP connection is determined not to be authorized by an established IP policy, the TCP connection may be terminated (523) and the event logged into a data file, which may or may not be the same as the data file in which the UDP and/or TCP communications and/or allowed events are logged.

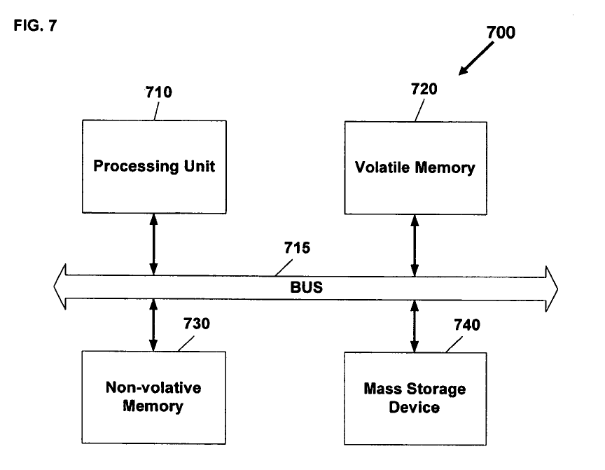

FIG. 7 is a block diagram of a computer system that may be used in accordance with at least one embodiment of the present invention. Computer system 700 may also include a volatile memory (e.g., a random access memory (RAM)) 720 to store executable instructions and information/data to be used by the executable instructions when executed by processing unit 710. Computer system 700 may still further include a non-volatile memory (e.g., a read only memory (ROM)) 730 to store instructions and static information for processing unit 710, and a mass storage device (e.g., a hard disk drive, a compact disc (CD) and associated CD drive, an optical disk and associated optical disk drive, a floppy disk and associated floppy disk drive, etc.) 740 that each may also be connected to bus 715 to enable each to have two-way communication across bus 715. In operation, embodiments of the present invention may be resident in processing unit 710 while being executed. For example, executing programmed instructions may cause processing unit 1210 to be configured to perform the functions described herein. The computer system illustrated in FIG. 7 provides the basic features of a computer/server system that may be used in conjunction with embodiments of the present invention.

It is contemplated that embodiments of the present invention may also be used with computer/server systems that include additional elements not included in computer system 700 in FIG. 7. For example, these addition elements may include, but are not limited to, additional processing units (e.g., parallel processing units, graphics processing units, etc.), bridges and/or interfaces to a variety of peripherals (e.g., monitor, keyboard, mouse, printer, joystick, biometric devices, speakers, external communications devices (e.g., a LAN, a WAN, a modem, a router, etc.)).

Additionally, any configuration of the computer system in FIG. 7 may be used with the various embodiments of the present invention. The executable instructions (i.e., computer program) implementing the present invention may be stored in any memory or storage device accessible to processing unit 710, for example, but not limited to, volatile memory 720, mass storage device 740, or any other local or remotely connected memory or storage device.

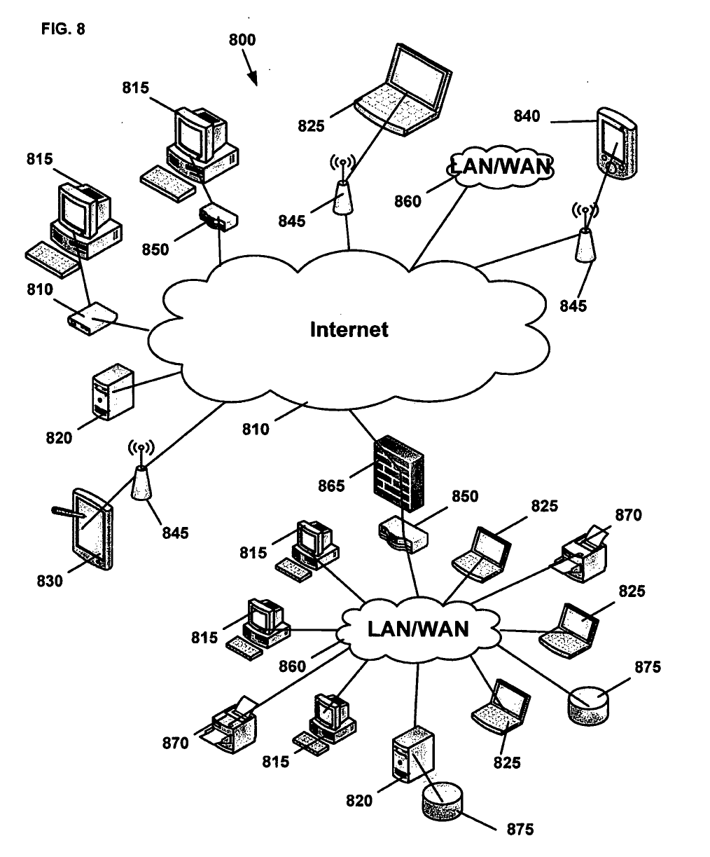

FIG. 8 is a diagram of a multiple network system that may be used in accordance with at least one embodiment of the present invention. In FIG. 8, Internet 810 has connected to it a variety of computers, servers and communications devices. For example, multiple desktop personal computers (PCs) 815, servers 820, lap top PCs 825, tablet PCs 830, and personal digital assistants (PDAs) 840 may be connected to Internet 810 via a variety of communications means. For example, the communications means may include wireless access points 845, such as seen connecting lap top PC 825, tablet PC 830, and PDA 840 to Internet 810; a router 850, as seen connecting a desktop PC to Internet 810; and a modem 855, as seen connecting another desktop PC to Internet 810. Internet 810 may also be connected to a LAN and/or WAN 860 via a firewall 865 and router 850. LAN and/or WAN 860 in turn may be directly connected to multiple desktop PCs 815, lap top PCs 825, multiple printers 870, one or more servers 820, and one or more mass storage devices 875, which may also be connected to one or more servers 820. Although the diagram in FIG. 8 is not exhaustive of all of the possible configurations and implementations, it is provided to illustrate a general network structure in which embodiments of the present invention may be implemented. Therefore, additional configurations and pieces of equipment are contemplated as being used with one or more embodiments of the present invention.

Thus, various embodiments provide one or more means for executing and performing an analysis of a 32/64-bit Microsoft computer's internal communications configuration, then can automatically apply connection policies and configure the computer for “secure communications”, by only allowing direct connections inside the network from authorized computers with approved connection policies from the private access network and can automatically terminate any attempted connection from a computer that is utilizing a defined connection from the public access network. Additionally, embodiments of the present invention may configure the network computer to allow the use of all logical communication ports and if an unauthorized event occurs, then terminate the event and allow authorized communications to continue on the same logical port.

In accordance with one or more embodiments, each of the features of the present invention may be separately and independently claimed. Likewise, in accordance with one or more embodiments, each utility program, program, and/or code segment/module may be substituted for an equivalent means capable of substantially performing the same function(s).

In accordance with an embodiment of the present invention, a method may include reading network connection policies, performing an analysis of the computer, monitoring all formal connections and enforcing the formal connections policies as defined by the policy file.

In accordance with an embodiment of the present invention, a method as substantially shown and described herein.

In accordance with another embodiment of the present invention, a system and method as substantially shown and described herein.

In accordance with yet another embodiment of the present invention, a computer and method as substantially shown and described herein.

In accordance with still another embodiment of the present invention, a computer network and method as substantially shown and described herein.

Although the present invention has been disclosed in detail, it should be understood that various changes, substitutions, and alterations can be made herein. Moreover, although software and hardware are described to control certain functions, such functions can be performed using either software, hardware or a combination of software and hardware, as is well known in the art. Other examples are readily ascertainable by one skilled in the art and can be made without departing from the spirit and scope of the present invention as defined by the following claims.

What is claimed is:

1. A method for protecting connections in a private access network from unauthorized connections from a public access network, the method comprising:
retrieving all media address codes (MAC) and Internet protocol (IP) addresses in a computer connected to a private access network;
performing an analysis of a communications configuration of the computer;
analyzing all network shares in the computer;
retrieving all communications connections policies for the computer;
configuring the computer for secure network communications using the communications connections policies;
allowing a network connection, if the network connection is an approved connection in the private access network; and
terminating the network connection and logging the IP address of the terminated network connection, if the network connection is from the public access network.

2. The method of claim 1 wherein the retrieving all media address codes (MAC) and Internet protocol (IP) addresses in the computer comprises:
establishing a Winsock interface to an operating system in the computer;
establishing an Iphlapi interface to the operating system in the computer and reading an IP policy file; and
establishing a PIP_ADAPTER_INFO table, filling a buffer with information associated with network adapters on the computer, and enumerating the network adapters in the table to retrieve all MAC codes and descriptions.

3. The method of claim 1 wherein the performing an analysis of a communications configuration of the computer comprises:
capturing a TCP table and a UDP table.

4. The method of claim 3 wherein the analyzing all network shares in the computer comprises:
capturing a TCP table and a UDP table including
obtaining the TCP table and its entries; and
obtaining the UDP table and its entries.

5. The method of claim 1 wherein the analyzing a plurality of network shares comprises:
establishing an interface to a network application programming interface (API) within the operating system;
checking for the existence of an administrative hard drive share and, if present, removing it from the computer;
checking for the existence of an administrative root folder share and, if present, removing it from the computer; and
obtaining an active shares list.

6. The method of claim 5 wherein the removing each of the administrative shares from the computer comprises:
removing the administrative share from the computer using a NetShareDel( )function.

7. The method of claim 5 wherein the obtaining an active shares list comprises:
obtaining an active shares list using a NetShareEnum( )function.

8. The method of claim 1 wherein the retrieving all communications connections policies for the computer comprises:
retrieving all communications connections policies for the computer from a policy data file.

9. The method of claim 1 wherein the configuring the computer for secure network communications using the communications connections policies comprises:
configuring the computer for secure network communications using the communications connections policies to prohibit network connections from the public access network and permit network connections from approved connections in the private access network.

10. The method of claim 9 wherein the configuring the computer for secure network communications using the communications connections policies to prohibit network connections from the public access network and permit network connections from approved connections in the private access network comprises:
executing a parallel thread to monitor network shares in the computer; and
executing another parallel thread to monitor the TCP and UDP tables in the computer.

11. The method of claim 10 wherein the executing the parallel thread to monitor network shares in the computer comprises:
establishing an interface to a NetAPI within an operating system of the computer,
checking for the existence of an administrative hard drive share and, if present, removing it,
checking for the existence of an administrative root folder share and, if present, removing it, and
obtaining an active shares list,
starting another parallel thread to monitor network shares, and, if a new network share has been created, deleting the new network share according to the communications connections policies, and
continuing to monitor the network shares.

12. The method of claim 10 wherein the executing the another parallel thread to monitor the TCP and UDP tables in the computer comprises:
retrieving the UDP table and entries and logging UDP communications to a data file;
retrieving the TCP table and entries and logging TCP communications to another data file;
if a TCP connection is not allowed by the communications connections policies, terminating the TCP connection and logging an associated event to said another data file; and
if the TCP connection is allowed by the communications connections policies, logging the associated event to said another data file.

13. A machine-readable medium having stored thereon a plurality of executable instructions to perform a method for protecting connections in a private access network from unauthorized connections from a public access network, the method comprising:
retrieving all media address codes (MAC) and Internet protocol (IP) addresses in a computer connected to a private access network;
performing an analysis of a communications configuration of the computer;
analyzing all network shares in the computer;
retrieving all communications connections policies for the computer;
configuring the computer for secure network communications using the communications connections policies;
allowing a network connection, if the network connection is an approved connection in the private access network; and
terminating the network connection and logging the IP address of the terminated network connection, if the network connection is from the public access network.

14. The machine-readable medium of claim 13 wherein the retrieving all media address codes (MAC) and Internet protocol (IP) addresses in the computer comprises:
establishing a Winsock interface to an operating system in the computer;
establishing an Iphlapi interface to the operating system in the computer and reading an IP policy file; and
establishing a PIP_ADAPTER_INFO table, filling a buffer with information associated with network adapters on the computer, and enumerating the network adapters in the table to retrieve all MAC codes and descriptions.

15. The machine-readable medium of claim 13 wherein the performing an analysis of a communications configuration of the computer comprises:
capturing a TCP table and a UDP table.

16. The machine-readable medium of claim 15 wherein the analyzing all network shares in the computer comprises:
capturing a TCP table and a UDP table including
obtaining the TCP table and its entries; and
obtaining the UDP table and its entries.

17. The machine-readable medium of claim 13 wherein the analyzing a plurality of network shares comprises:
establishing an interface to a network application programming interface (API) within the operating system;
checking for the existence of an administrative hard drive share and, if present, removing it from the computer;
checking for the existence of an administrative root folder share and, if present, removing it from the computer; and
obtaining an active shares list.

18. The machine-readable medium of claim 17 wherein the removing each of the administrative shares from the computer comprises:
removing the administrative share from the computer using a NetShareDel( )function.

19. The machine-readable medium of claim 17 wherein the obtaining an active shares list comprises:
obtaining an active shares list using a NetShareEnum( )function.

20. The machine-readable medium of claim 13 wherein the retrieving all communications connections policies for the computer comprises:
retrieving all communications connections policies for the computer from a policy data file.

21. The machine-readable medium of claim 13 wherein the configuring the computer for secure network communications using the communications connections policies comprises:
configuring the computer for secure network communications using the communications connections policies to prohibit network connections from a public access network and permit network connections from approved connections in the private access network.

22. The machine-readable medium of claim 13 wherein the configuring the computer for secure network communications using the communications connections policies to prohibit network connections from a public access network and permit network connections from approved connections in the private access network comprises:
executing a parallel thread to monitor network shares in the computer; and
executing another parallel thread to monitor the TCP and UDP tables in the computer.

23. The machine-readable medium of claim 22 wherein the executing the parallel thread to monitor network shares in the computer comprises:
establishing an interface to a NetAPI within an operating system of the computer,
checking for the existence of an administrative hard drive share and, if present, removing it,
checking for the existence of an administrative root folder share and, if present, removing it, and
obtaining an active shares list,
starting another parallel thread to monitor network shares, and, if a new network share has been created, deleting the new network share according to the communications connections policies, and
continuing to monitor the network shares.

24. The machine-readable medium of claim 22 wherein the executing the another parallel thread to monitor the TCP and UDP tables in the computer comprises:
retrieving the UDP table and entries and logging UDP communications to a data file;
retrieving the TCP table and entries and logging TCP communications to another data file;
if a TCP connection is not allowed by the communications connections policies, killing the TCP connection and logging the event to the another data file; and
if the TCP connection is allowed by the communications connections policies, logging the event to the another data file.

25. An apparatus comprising a computer system including a processing unit and a volatile memory, the computer system including:
means for retrieving all media address codes (MAC) and Internet protocol (IP) addresses in the computer system connected to a private access network;
means for performing an analysis of a communications configuration of the computer system;
means for analyzing all network shares in the computer system;
means for retrieving all communications connections policies for the computer system;
means for configuring the computer system for secure network communications using the communications connections policies;
means for allowing a network connection to the computer system, if the network connection is an approved connection in the private access network; and
means for terminating the network connection to the computer system and logging the IP address of the terminated network connection, if the network connection is from the public access network.

26. The apparatus of claim 25 wherein the means for retrieving all media address codes (MAC) and Internet protocol (IP) addresses in the computer system comprises:
means for establishing a Winsock interface to an operating system in the computer system;
means for establishing an Iphlapi interface to the operating system in the computer system and reading an IP policy file; and
means for establishing a PIP_ADAPTER_INFO table, filling a buffer with information associated with network adapters on the computer system, and enumerating the network adapters in the table to retrieve all MAC codes and descriptions for the computer system.

27. The apparatus of claim 25 wherein the means for performing an analysis of a communications configuration of the computer system comprises:
means for capturing a TCP table and a UDP table in the computer system.

28. The apparatus of claim 27 wherein the means for analyzing all network shares in the computer system comprises:
means for capturing a TCP table and a UDP table in the computer system including
obtaining the TCP table and its entries; and
obtaining the UDP table and its entries.

29. The apparatus of claim 25 wherein the means for analyzing a plurality of network shares comprises:
means for establishing an interface to a network application programming interface (API) within the operating system of the computer system;
means for checking for the existence of an administrative hard drive share and, if present, removing it from the computer system;
means for checking for the existence of an administrative root folder share and, if present, removing it from the computer system; and
means for obtaining an active shares list from the computer system.

30. The apparatus of claim 29 wherein the removing each of the administrative shares from the computer system comprises:
removing the administrative share from the computer system using a NetShareDel( ) function.

31. The apparatus of claim 29 wherein the means for obtaining an active shares list from the computer system comprises:
obtaining an active shares list from the computer system using a NetShareEnum( ) function.

32. The apparatus of claim 25 wherein the means for retrieving all communications connections policies for the computer system comprises:
retrieving all communications connections policies for the computer system from a policy data file.

33. The apparatus of claim 25 wherein the means for configuring the computer system for secure network communications using the communications connections policies comprises:
means for configuring the computer system for secure network communications using the communications connections policies to prohibit network connections to the computer system from the public access network and to permit network connections to the computer system from approved connections in the private access network.

34. The apparatus of claim 33 wherein the means for configuring the computer system for secure network communications using the communications connections policies to prohibit network connections to the computer system from the public access network and to permit network connections to the computer system from approved connections in the private access network comprises:
means for executing a parallel thread to monitor network shares in the computer system; and
means for executing another parallel thread to monitor the TCP and UDP tables in the computer system.

35. The apparatus of claim 34 wherein the means for executing the parallel thread to monitor network shares in the computer system comprises:
establishing an interface to a NetAPI within the operating system of the computer system,
checking for the existence of an administrative hard drive share on the computer system and, if present, removing it,
checking for the existence of an administrative root folder share on the computer system and, if present, removing it,
obtaining an active shares list from the computer system,
starting another parallel thread to monitor network shares in the computer system, and, if a new network share has been created, deleting the new network share from the computer system according to the communications connections policies, and
continuing to monitor the network shares in the computer system.

36. The apparatus of claim 34 wherein the means for executing the another parallel thread to monitor the TCP and UDP tables in the computer comprises:
retrieving the UDP table and entries and logging UDP communications to a data file on the computer system;
retrieving the TCP table and entries and logging TCP communications to another data file on the computer system;
if a TCP connection is not allowed by the communications connections policies, terminating the TCP connection and logging the event to said another data file; and
if the TCP connection is allowed by the communications connections policies, logging the event to said another data file.
